(19) United States
(12) Patent Application Publication
(10) Pub. No.: US 2025/0322771 A1
(43) Pub. Date: Oct. 16, 2025

(54) RFID LABEL FOR MEDICAL DEVICE

(71) Applicant: DAIO PAPER CORPORATION, Ehime (JP)

(72) Inventors: Takuro SHIMADA, Ehime (JP); Alina KAN, Ehime (JP); Taro IKAWA, Ehime (JP); Hitoshi NAKANE, Tokyo (JP); Hiroshi YAMAKAMI, Gunma (JP); Ryoya ENDO, Kanagawa (JP)

(21) Appl. No.: 18/866,318

(22) PCT Filed: May 12, 2023
(86) PCT No.: PCT/JP2023/017879

§ 371 Date: Nov. 15, 2024

(30) Foreign Application Priority Data
May 20, 2022 (JP) 2022-083421

(51) Int. Cl. G09F 3/02; G06K 19/077; G09F 3/10

(52) U.S. Cl. CPC G09F 3/02; G06K 19/0776; G09F 3/10; G09F 2003/0225; G09F 2003/023

(57) ABSTRACT

An RFID label for a medical device according to the present invention is an RFID label for a medical device to be attached to the medical device, the RFID label including a label body having a first surface on which printing is possible and a second surface; a first adhesive layer provided on the second surface of the label body; an RFID inlay including a base film having a first surface attached to the second surface of the label body through the first adhesive layer and a second surface on an opposite side of the first surface, and having an area smaller than that of the label body, an antenna, and an IC chip; and a second adhesive layer provided on the second surface of the base film, wherein the first adhesive layer has an intermediate portion arranged between the label body and the base film, and an outer peripheral portion surrounding an outer periphery of the base film, and a label attachment surface is formed by a surface of the outer peripheral portion of the first adhesive layer on an opposite side of the label body and a surface of the second adhesive layer on the opposite side of the label body.

### TECHNICAL FIELD

The present invention relates to an RFID label for a medical device that can be attached to medical devices such as blood collection tubes, blood transfusion packs, urine analysis cups, and the like.

### BACKGROUND ART

RFID (Radio Frequency Identification) labels attached to adherends have become popular for physical distribution management and commodity management. The RFID label is a label having an RFID inlay. The RFID inlay includes an IC chip and an antenna electrically connected to the IC chip.

As an antenna for an RFID tag, there is known an antenna having a feed terminal to which an IC chip is connected, a loop antenna connected to the feed terminal, and a bypass conductor for bypassing the loop of the loop antenna (for example, see Patent Documents 1 and 2.).

### CITATION LIST

### Patent Document

Patent document 1: Japanese Unexamined Patent Application Publication No. 2007-19905

Patent document 2: WO 2006/077645

### SUMMARY OF INVENTION

### Technical Problem

Patent Documents 1 and 2 indicate that a good communication distance can be obtained in a frequency band in which an RFID tag performs wireless communication by resonating a capacitance component inside an IC chip and an inductance component of a bypass conductive wire included in an antenna.

Here, an RFID tag is generally stored in a state in which adhesive is provided on both sides thereof and a label and release paper are attached thereto. When an RFID tag is attached to an adherend such as a container for a liquid, the release paper is peeled off and the RFID tag is attached to the adherend through the adhesive. It is important that the RFID tag is attached to the adherend without being peeled off from the adherend.

However, when a conventional RFID tag is attached to a curved surface of the adherend through the adhesive, there is a problem that the conventional RFID tag cannot maintain a state in which the RFID tag is attached to the curved surface of the adherend for a long time and the RFID tag peels off.

In view of the above, it is an object of an aspect of the present invention to provide an RFID label for a medical device which can maintain a state in which the RFID label is attached to the adherend for a long time and is difficult to peel off from the adherend.

### Solution to Problem

An RFID label for a medical device according to an embodiment of the present invention is an RFID label for a medical device to be attached to the medical device, the RFID label including a label body having a first surface on which printing is possible and a second surface; a first adhesive layer provided on the second surface of the label body; an RFID inlay including a base film having a first surface attached to the second surface of the label body through the first adhesive layer and a second surface on an opposite side of the first surface, and having an area smaller than that of the label body, an antenna, and an IC chip; and a second adhesive layer provided on the second surface of the base film, wherein the first adhesive layer has an intermediate portion arranged between the label body and the base film, and an outer peripheral portion surrounding an outer periphery of the base film, and a label attachment surface is formed by a surface of the outer peripheral portion of the first adhesive layer on an opposite side of the label body and a surface of the second adhesive layer on the opposite side of the label body.

### Advantageous Effects of Invention

An RFID label for a medical device according to an embodiment of the present invention can be maintained in a state of being attached to an adherend for a long time and be difficult to peel from the adherend.

### BRIEF DESCRIPTION OF DRAWINGS

FIG. 1 is a diagram illustrating an example of the appearance of a blood collection tube to which an RFID label for a medical device according to an embodiment of the present invention is attached.

FIG. 2 is a plan view of an RFID label for a medical device according to an embodiment of the present invention.

FIG. 3 is a cross-sectional view A-A of FIG. 2.

FIG. 4 is a plan view of an RFID inlay.

FIG. 5 is a flowchart illustrating an example of a method of manufacturing an RFID label for a medical device.

FIG. 6 is a cross-sectional view of an RFID label for a medical device of Comparative Example 1.

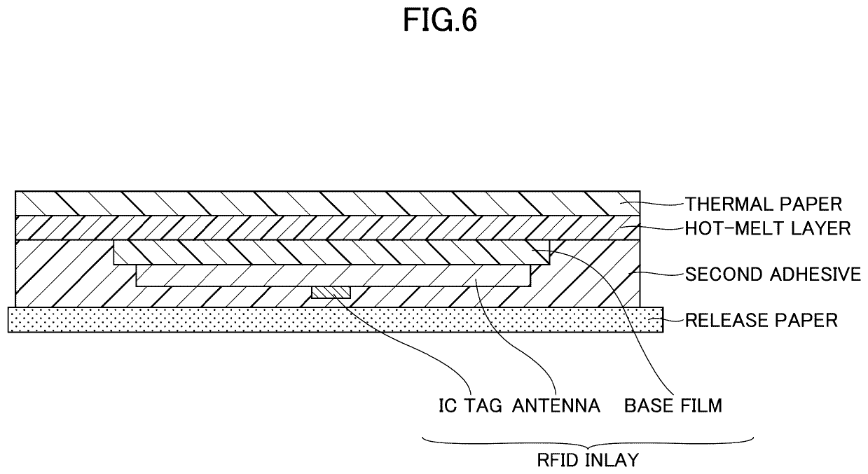

FIG. 7 is a diagram illustrating measurement results obtained by measuring the peeling force of the medical device RFID labels of Example 1 and Comparative Example 1 at room temperature.

FIG. 8 is a diagram illustrating measurement results obtained by measuring the peeling force of the medical device RFID labels of Example 1 and Comparative Example 1 at low temperature and low humidity.

FIG. 9 is a diagram illustrating measurement results obtained by measuring the peeling force of the medical device RFID labels of Example 1 and Comparative Example 1 at high temperature and high humidity.

FIG. 10 is a diagram illustrating observation results of chip marks after printing of the medical device RFID labels of Example 1 and Comparative Example 1.

### DESCRIPTION OF EMBODIMENTS

Embodiments of the present invention will now be described in detail. In order to facilitate understanding of the explanations, the same components in the drawings are denoted by the same reference numerals, and redundant explanations will be omitted. The scale of each member in the drawings may differ from the actual scale. In the present specification, “to” indicating a numerical range means that the numerical values described before and after “to” are included as a lower limit value and an upper limit value, unless otherwise stated.

An RFID label for a medical device according to an embodiment of the present invention will be described. In explaining the RFID label for a medical device according to the present embodiment, a blood collection tube which is a container for storing a liquid, to which the RFID label for a medical device according to the present embodiment is attached, will be described.

In the present embodiment, a case where the container for storing the liquid is a blood collection tube will be described, but the blood collection tube is an example of a container for storing blood as a liquid, and may be, for example, a container for storing a liquid other than blood such as urine, a drink, medicine, water, etc., such as a test tube, a urine collection tube, an ampoule, etc.

### Blood Collection Tube

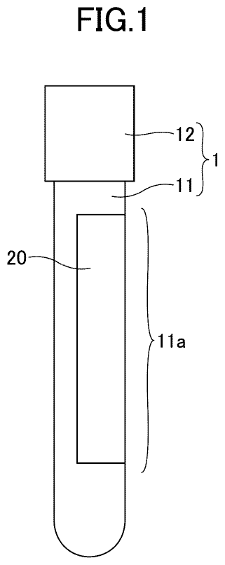

FIG. 1 is a diagram illustrating an example of the appearance of a blood collection tube to which the RFID label for a medical device according to the present embodiment is attached. As illustrated in FIG. 1, a blood collection tube 1 has a blood collection tube body 11 having a curved surface formed into a circular tube with one end open and the other end closed, and a sealing plug 12 for tightly plugging the open end of the blood collection tube body 11.

The blood collection tube body 11 is made of, for example, synthetic resin such as polyethylene terephthalate (PET) or glass.

The blood collection tube body 11 has a medical device RFID label 20 (RFID label for medical device) attached within a predetermined attachment area 11a on the outer periphery thereof.

The sealing plug 12 is made of an elastic member such as rubber or synthetic resin.

### Medical Device RFID Label

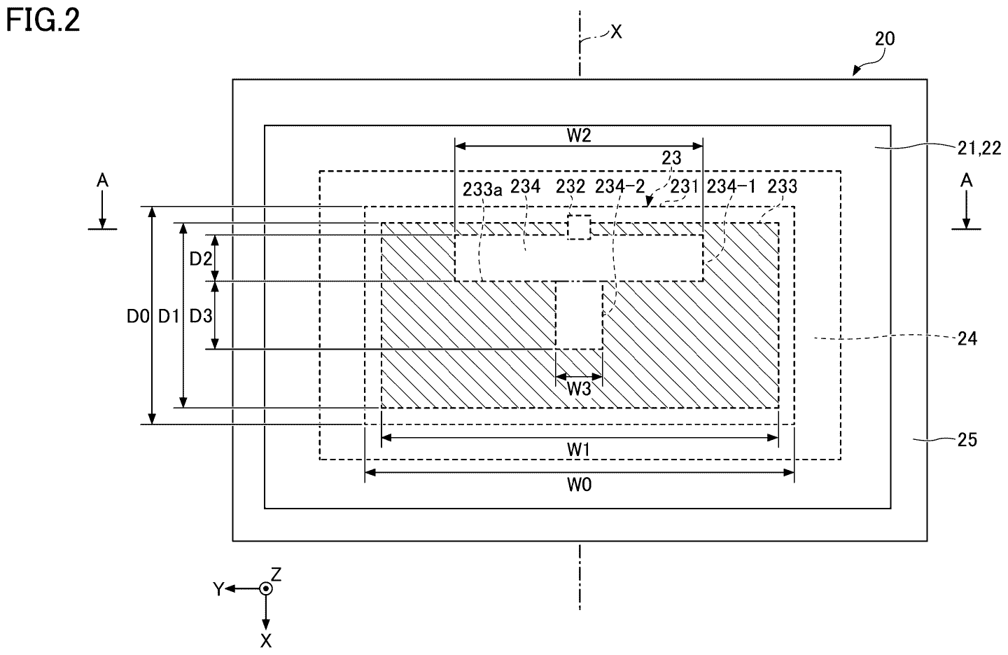

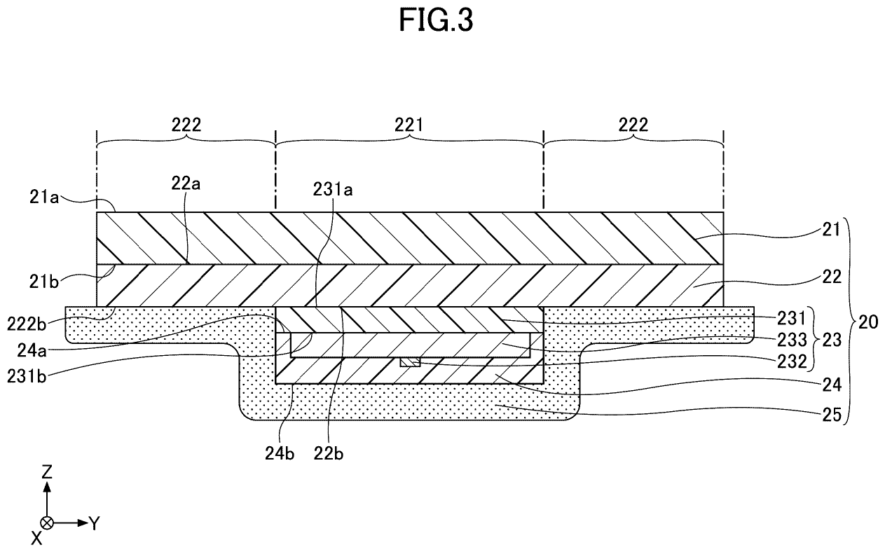

FIG. 2 is a plan view of the medical device RFID label 20 according to the present embodiment, and FIG. 3 is a cross-sectional view taken along the line A-A in FIG. 2. As illustrated in FIG. 2, the medical device RFID label 20 according to the present embodiment is formed in a substantially rectangular shape in a plan view. The shape of the medical device RFID label 20 in a plan view is not limited to a substantially rectangular shape, and may be formed in any shape as appropriate, such as a polygonal shape, including a substantially square shape, a substantially triangular shape, or a substantially hexagonal shape, a substantially circular shape, a substantially elliptical shape, and the like.

As illustrated in FIG. 3, the medical device RFID label 20 has a label body 21, a first adhesive layer 22, an RFID inlay 23, and a second adhesive layer 24. The medical device RFID label 20 is formed by laminating the label body 21, the first adhesive layer 22, the RFID inlay 23, and the second adhesive layer 24 in this order from the label body 21 side toward the second adhesive layer 24 side. In the medical device RFID label 20, a label attachment surface is formed of a surface (lower surface) of the outer peripheral portion 222 of the first adhesive layer 22 on the side opposite to the label body (FIG. 3, lower side) and a surface (lower surface) 24b of the second adhesive layer 24 on the side opposite to the label body (FIG. 3, lower side). The medical device RFID label 20 is used so that the label body 21 can be viewed from the outside by attaching the second adhesive layer 24 to the blood collection tube body 11.

In FIGS. 2 and 3, the thickness direction (vertical direction) of the medical device RFID label 20 is a Z-axis direction, the depth direction of the medical device RFID label 20 is an X-axis direction, and the width direction is a Y-axis direction. The label body 21 side in the Z-axis direction is a +Z-axis direction, and the second adhesive layer 24 side is a −Z-axis direction. In the following description, for convenience of explanation, the +Z-axis direction is referred to as up or upper, and the −Z-axis direction is referred to as down or lower, but these directions do not express a universal vertical direction.

Furthermore, the term “substantially” with regard to the shape in a plan view means a shape that is acceptable in the technical field to which the present invention belongs. “Substantially” with regard to a substantially rectangular shape, a substantially square shape, a substantially triangular shape, and a substantially polygonal shape includes, for example, a shape in which a corner portion is chamfered, a shape in which a part of a side is slightly expanded or depressed, a shape in which a side is slightly curved, and the like. “Substantially” with regard to a substantially circular shape and a substantially elliptical shape in a plan view includes, for example, a shape in which a part of a circumference is slightly expanded or depressed, a shape in which a part of a circumference is slightly straight or oblique, and the like.

The label body 21 may be formed in any desired shape, such as a substantially polygonal shape, including a substantially rectangular shape, a substantially square shape, a substantially triangular shape, or a substantially hexagonal shape, a substantially circular shape, a substantially elliptical shape, etc., and in the present embodiment is formed in a substantially rectangular shape as illustrated in FIG. 2.

As illustrated in FIG. 3, the label body 21 is provided on a surface (upper surface) 22a of the first adhesive layer 22 on the opposite side of (in FIG. 3, upper) the RFID inlay 23. The label body 21 has a printable first surface 21a and a second surface 21b on the opposite side of the first surface 21a in contact with the first adhesive layer 22.

The label body 21 has a printing substrate and a color-changing underlayer, and the color-changing underlayer is laminated on the printing substrate and integrated with the printing substrate.

The printing substrate may be either a transparent substrate or an opaque substrate. The printing substrate may be, for example, a transparent synthetic resin film, an opaque synthetic resin film, paper, or the like. The material of the synthetic resin film is not particularly limited, and examples include a mixture of one kind or two or more kinds selected from polyester resins such as polyethylene terephthalate and polylactic acid; olefin resins such as polypropylene and cyclic olefin; styrene resins such as polystyrene and styrene-butadiene copolymers; polyamide resins; and thermoplastic resins such as vinyl chloride resins. The synthetic resin film may include one resin layer or a plurality of different resin layers of the same or different kinds. The printing substrate may have heat shrinkability (for example, the property of heat shrinkage when heated to 80° C. to 120° C.), but is preferably a substrate having substantially no heat shrinkability. Substantially no heat shrinkability means that the printing substrate does not shrink due to heat significantly, and includes a case where the printing substrate does not shrink due to heat at all or a case where the printing substrate slightly shrinks at 80° C. to 120° C. The thickness of the printing substrate is not particularly limited, and may be, for example, 20 μm to 300 μm.

As the paper, a paper substrate such as plain paper, high-quality paper, coated paper, kraft paper, glassine paper, synthetic paper, flame-retardant paper processed by a flame retardant process, glass fiber paper, latex or melamine-impregnated paper can be used.

The color-changing underlayer is provided on the upper surface of the printing substrate. Preferably, for example, the color-changing underlayer has any one of the following properties: (a) a property in which the heated portion or the surroundings thereof change to a color different from the desired color, become colorless, or colorless and transparent upon heating, even though the layer had a desired color before laser irradiation or heating by a heating device such as a thermal head; and (b) a property in which the heated portion or the surroundings thereof change to a desired color upon heating, even though the layer was colorless or colorless and transparent before heating.

As the label body 21, it is preferable to use, for example, thermal paper that develops color due to heat generated by heating with a heating device.

When the label body 21 is thermal paper, the color-changing underlayer contains, for example, a dye such as leuco dye (electron donor) that is a coloring agent and a developer (electron acceptor) that is an acidic substance in a state in which these are solid fine particles that are dispersed in a binder resin, and may contain various additives as necessary. When the color-changing underlayer is irradiated with a laser or heated by a heating device such as a thermal head, both components of the leuco dye and the acidic substance react with each other to develop infrared color and absorb light in a specific wavelength range. When the color-changing underlayer is colorless and transparent before heating (when the layer contains a coloring agent, the layer exhibits a desired color), the heated portion thereof changes to a desired color (a color different from that of the coloring agent, if a coloring agent is contained) by heating with a heating device.

At least the first surface 21a of the label body 21 may be subjected to an alcohol-resistant treatment using a polyethylene film or various surface treatment agents.

As illustrated in FIG. 3, the first adhesive layer 22 is provided on the second surface 21b of the label body 21 and on the surface (the first surface 231a of the base film 231 to be described later) of the RFID inlay 23 on the side opposite to the blood collection tube 1 (upper side in FIG. 3).

The first adhesive layer 22 is formed in substantially the same shape and size as the label body 21 so as to correspond to the label body 21 in a plan view. “The same” means that the first adhesive layer 22 may be formed in any appropriate shape such as a substantially polygonal shape including a substantially rectangular shape, a substantially square shape, a substantially triangular shape, or a substantially hexagonal shape, a substantially circular shape, a substantially elliptical shape, or the like, and in this embodiment, the first adhesive layer 22 is formed in a substantially rectangular shape as illustrated in FIG. 2.

The area of the first adhesive layer 22 in a plan view is preferably 1.5 to 3 times the area of the second adhesive layer 24, more preferably 1.7 to 2.7 times, and even more preferably 2.0 to 2.5 times.

As illustrated in FIG. 3, the first adhesive layer 22 has an intermediate portion 221 arranged between the label body 21 and the base film 231, and an outer peripheral portion 222 surrounding the outer periphery of the base film 231.

The first adhesive layer 22 exhibits adhesiveness by being attached to an adherend, and can be formed by an adhesive referred to as a pressure-sensitive adhesive. As the adhesive used for the first adhesive layer 22, a general adhesive can be used, and for example, an adhesive having, as a base polymer, an acrylic resin, a silicone resin, a polyester resin, a polyurethane resin, a polyether resin, a rubber resin, or the like can be used. Among these, an acrylic adhesive is preferable from the viewpoint of transparency, adhesive strength, reliability, weather resistance, heat resistance, reworkability, and the like. When an acrylic adhesive is used as the adhesive, a crosslinking agent is usually included. The base polymer refers to a polymer which is a main component among the solids constituting the adhesive.

The acrylic adhesive is not particularly limited, but (meth) acrylic ester-based resins obtained by polymerizing (meth) acrylic esters such as (meth) butyl acrylate, (meth) ethyl acrylate, (meth) isooctyl acrylate, and (meth) 2-ethylhexyl acrylate, and copolymer resins using two or more kinds of these (meth) acrylic esters are preferably used as the base polymer. Polar monomers may be copolymerized with these resins. Examples of the polar monomers include monomers having polar functional groups such as carboxyl groups, hydroxyl groups, amide groups, amino groups, and epoxy groups such as (meth) acrylic acid, (meth) 2-hydroxypropyl acrylate, (meth) 2-hydroxyethyl acrylate, (meth) acrylamide, 2-N, N-dimethylaminoethyl (meth) acrylate, and glycidyl (meth) acrylate.

The thickness of the first adhesive layer 22 is preferably, for example, 10 μm to 30 μm.

As illustrated in FIG. 3, the RFID inlay 23 is provided on a surface (lower surface) 22b of the first adhesive layer 22 on the blood collection tube body 11 side (FIG. 3, lower side), and is arranged so as to be sandwiched between the first adhesive layer 22 and the second adhesive layer 24.

The RFID inlay 23 has, for example, a base film 231 having an area smaller than that of the label body, an IC chip 232 for recording identification information, and an antenna 233 formed of a loop-shaped conductor connected to the IC chip 232.

As illustrated in FIG. 3, the base film 231 is a plate-like member formed in a rectangular shape. The base film 231 has a first surface 231a attached to the second surface 21b of the label body 21 via the first adhesive layer 22, and a second surface 231b as a surface (lower surface) on the adherend side (FIG. 3, lower side) opposite to the first surface 231a.

In the base film 231, the first adhesive layer 22 is positioned on the first surface 231a thereof, and is attached to the lower surface 22b of the first adhesive layer 22. The base film 231 may be provided in a state in which at least a part thereof is buried in the first adhesive layer 22 in the thickness direction.

The base film 231 has an outer shape corresponding to the blood collection tube 1 as illustrated in FIG. 1, for example. For example, it is preferable that the depth D0 of the base film 231 is shorter than the minimum value of the outer circumference within the predetermined attachment range 11a of the blood collection tube 1. Thus, for example, as illustrated in FIG. 1, the RFID inlays 23 can be attached to the blood collection tube 1 so that the RFID inlays 23 do not overlap. It is also preferable that the lateral width WO of the base film 231 falls within the predetermined attachment range 11a of the blood collection tube 1.

It is preferable that the center portion of the label body 21 and the center portion of the base film 231 are arranged to substantially overlap each other in a plan view.

As materials for forming the base film 231, synthetic resins such as polyethylene terephthalate (PET), PET-G (terephthalic acid-cyclohexane dimethanol-ethylene glycol copolymer), polycarbonate, polyamide, polyimide, cellulose diacetate, cellulose triacetate, polystyrene, ABS, polyacrylic ester, polypropylene, polyethylene, and polyurethane; and paper; and the like can be used. The base film 231 may be composed of 1 film made of the synthetic resin or the like, or a composite film made by laminating multiple films made of the synthetic resin or the like can be used.

The bending rigidity of the base film 231 is preferably lower than the bending rigidity of the label body 21.

As illustrated in FIG. 3, the IC chip 232 is provided on the second surface 231b, which is the surface (lower surface) of the base film 231 on the adherend side (FIG. 3, lower side). The IC chip 232 is an integrated circuit for an RFID system in which identification information is recorded, and is electrically connected to the antenna 233. The IC chip 232 receives, by the antenna 233, radio waves transmitted at a predetermined radio frequency (for example, 920 MHz band: 860 MHz to 960 MHz) from a tag reader (not illustrated) of the RFID inlay 23, generates electric power by the received radio waves, and is activated. The IC chip 232 uses the generated electric power to transmit, to the tag reader, radio waves containing identification information recorded in advance in the IC chip 232.

As illustrated in FIG. 3, the antenna 233 is provided on the second surface 231b of the base film 231 in the same manner as the IC chip 232.

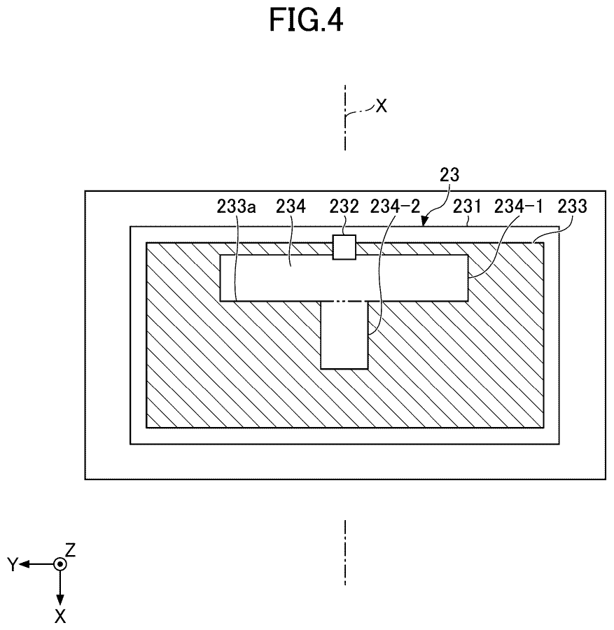

As illustrated in FIG. 4, the antenna 233 is connected to the IC chip 232. Although the outer shape of the antenna 233 is a rectangle, the shape is not particularly limited, and the shape may be a polygon other than a rectangle, a circle, or any other shape according to the size of the base film 231 and installation area, etc.

The antenna 233 is formed in a loop shape with a conductor having high conductivity (for example, metals such as copper and aluminum). As illustrated in FIG. 4, the antenna 233 has an inner circumference 233a that is T-shaped, and no conductor is formed inside the inner circumference 233a. The portion inside the inner circumference 233a where no conductor is formed is referred to as the opening 234. As described above, the antenna 233 is formed with a loop-shaped conductor connected to the IC chip 232, and has the T-shaped opening 234 where no conductor is formed. The opening 234 may be formed symmetrically with respect to the center line X of the opening 234. Note that, in the symmetrical shape, a degree of error and deviation that does not impair the effect of the antenna 233 is allowed. The shape of the opening 234 of the antenna 233 is not limited to being T-shaped, and is not particularly limited as long as good communication characteristics are obtained.

The impedance of the antenna 233 varies depending on whether or not liquid is contained in the blood collection tube 1. If the value of the impedance of the antenna 233 is within a range of, for example, 190Ω to 240Ω at 920 MHz, it can be said that although the change in the resonance frequency is small, good communication characteristics can be obtained regardless of the presence or absence of liquid in the blood collection tube 1. Thus, in the RFID inlay 23, the antenna 233 has the T-shaped opening 234, and, therefore, a good communication distance can be obtained regardless of the presence or absence of liquid.

The resonance frequency of the antenna 233 can be adjusted by the T-shaped inner area of the inner circumference 233a of the antenna 233, and can be easily adjusted so as to obtain good communication characteristics.

Moreover, the antenna 233 has the T-shaped inner circumference 233a, and, therefore, the impedance of the antenna 233, especially the impedance when liquid is in the blood collection tube 1, can be easily adjusted.

Furthermore, the impedance characteristics of the antenna 233 can be easily adjusted when a liquid is inserted, by changing the T-shaped shape of the opening 234 (non-similar shape) while maintaining the area of the opening 234.

When the area of the opening 234 of the antenna 233 is reduced, the impedance characteristics of the antenna 233 can be further changed by reducing the area of the opening 234 while maintaining the T-shaped similarity (similar shape).

As illustrated in FIG. 4, the opening 234 includes a first opening 234-1 extending in a direction parallel to one side of the rectangle on which the IC chip 232 is mounted (Y-axis direction), and a second opening 234-2 connected to the center portion of the first opening 234-1 and extending in a direction orthogonal to one side of the rectangle on which the IC chip 232 is mounted (+X-axis direction). Note that in FIG. 4, a two-dot chain line indicating a boundary between the first opening 234-1 and the second opening 234-2 is an imaginary line and does not actually exist.

The depth D1 and the lateral width W1 of the antenna 233 can be arbitrarily determined within the range of the depth D0 and the lateral width WO of the base film 231 as appropriate according to the frequency used by the RFID inlay 23.

The RFID inlay 23 is preferably attached to the blood collection tube 1 such that the longitudinal direction of the blood collection tube 1 and the direction (Y-axis direction) in which the first opening 234-1 extends are substantially parallel. Thus, better communication characteristics can be obtained. When the RFID inlay 23 is attached to the blood collection tube 1, there is no significant difference in the communication characteristics between the case where the RFID inlay 23 illustrated in FIG. 2 is oriented in the −Y-axis direction and the case where the RFID inlay is oriented in the +Y-axis direction toward the sealing plug 12 side of the blood collection tube 1, so that the RFID inlay 23 may be arranged so that the Y-axis direction of the RFID inlay 23 is oriented toward the sealing plug 12 side of the blood collection tube 1.

The RFID inlay 23 may be attached to the blood collection tube 1, for example, such that the longitudinal direction of the blood collection tube 1 intersects the direction in which the first opening 234-1 extends.

The width W2 and the depth D2 of the first opening 234-1 and the width W3 and the depth D3 of the second opening 234-2 may be arbitrarily determined according to the frequency used by the RFID inlay 23.

The antenna 233 is formed by a conductive material processed by, for example, press processing, etching processing, plating processing on a metal foil such as copper or aluminum, or silk screen printing with a metal paste, etc. When the conductive material is aluminum, the thickness of the conductive material may be, for example, 5 μm to 40 μm, preferably 7 μm to 30 μm.

In the above configuration, the IC chip 232 has an internal capacitance, and the internal capacitance and the inductance component of the antenna 233 constitute a resonance circuit (matching circuit). In this resonance circuit, at a resonance frequency at which the internal capacitance of the IC chip 232 resonates with the inductance component of the antenna 233, the imaginary component becomes almost 0, so that the impedance is matched and a sufficient communication distance can be secured. The RFID inlay 23 is configured to provide a good communication distance at a frequency of, for example, a 920 MHz band (860 MHz to 960 MHz, preferably 915 MHz to 935 MHz) regardless of the presence or absence of liquid (for example, blood) in the blood collection tube 1.

The second adhesive layer 24 is provided on the second surface 231b of the base film 231 so as to cover the RFID inlay 23 including the IC chip 232 and the antenna 233.

The second adhesive layer 24, similar to the first adhesive layer 22, exhibits adhesiveness by being attached to an adherend, and can be formed by what is referred to as a pressure-sensitive adhesive. The adhesive used for the second adhesive layer 24 can be the same as the adhesive used for the first adhesive layer 22, and the details thereof will be omitted.

The area of the second adhesive layer 24 is smaller than that of the first adhesive layer 22 in a plan view. In a plan view, the area of the second adhesive layer 24 is preferably 60 to 90 with respect to the area of the first adhesive layer 22.

The second adhesive layer 24 preferably overlaps the first adhesive layer 22 by 100% in a plan view, but may slightly protrude from the first adhesive layer 22. Even in this case, the second adhesive layer 24 preferably overlaps the first adhesive layer 22 by 90% or more in a plan view.

In the medical device RFID label 20, in order to protect the first adhesive layer 22 and the second adhesive layer 24, it is preferable to attach a release paper 25 to the attachment surface of the second adhesive layer 24 until the label is used. During use, the release paper 25 is peeled from the first adhesive layer 22 and the second adhesive layer 24, and the first adhesive layer 22 and the second adhesive layer 24 are attached to the blood collection tube body 11. By attaching the release paper 25 to the first adhesive layer 22 and the second adhesive layer 24, the adhesive strength of the first adhesive layer 22 and the second adhesive layer 24 can be maintained even if the blood collection tube 1 is stored during an unused period. Therefore, by peeling the release paper 25 from the first adhesive layer 22 and the second adhesive layer 24 during use, the medical device RFID label 20 can be securely attached to the blood collection tube 1 for use.

The bending rigidity of the release paper 25 is preferably less than the bending rigidity of the label body 21 and is preferably less than the bending rigidity of the base film 231. By reducing the bending rigidity of the release paper 25, the release paper 25 can be easily provided across the surface 222b of the outer peripheral portion 222 of the first adhesive layer 22 on the side opposite to the label body and the surface 24b of the second adhesive layer 24 on the side opposite to the label body without generating a gap.

### Method of Manufacturing Medical Device RFID Labels

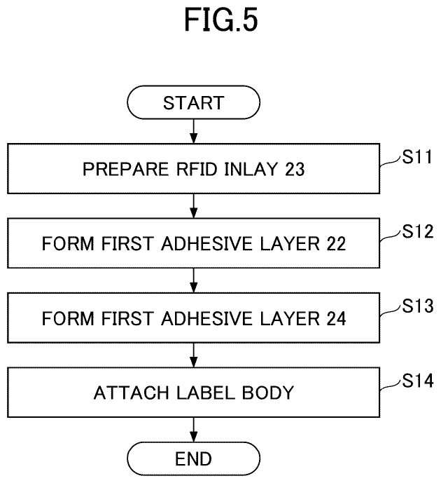

A method of manufacturing the medical device RFID label 20 will be described below. FIG. 5 is a flowchart illustrating an example of a method of manufacturing the medical device RFID label 20. As illustrated in FIG. 5, in the method of manufacturing the medical device RFID label 20, first, the RFID inlay 23 having the base film 231, the IC chip 232, and the antenna 233 is prepared (the RFID inlay 23 preparation step: step 11).

Next, an adhesive composition constituting the first adhesive layer 22 is applied to the surface of the RFID inlay 23 on the side of the base film 231 (the first surface 231a of the base film 231) and cured to form the first adhesive layer 22 (first adhesive layer forming step: step S12).

Next, an adhesive composition constituting the second adhesive layer 24 is applied to the second surface 231b of the base film 231, which is the surface on the adherent-side, so that the area of the second adhesive layer is smaller than that of the first adhesive layer 22 in the plan view of the RFID inlay 23, and is cured, and the second adhesive layer 24 having an area smaller than that of the first adhesive layer 22 in the plan view is formed (second adhesive layer forming step: step S13).

Next, the label body 21 is attached to the upper surface 22a of the first adhesive layer 22, which is the surface opposite to the RFID inlay 23 (label layer attaching step: step S14).

Thus, the medical device RFID label 20 is obtained.

As described above, the medical device RFID label 20 according to the present embodiment has the label body 21, the first adhesive layer 22, the RFID inlay 23, and the second adhesive layer 24; the first adhesive layer 22 has the intermediate portion 221 and the outer peripheral portion 222; and a label attachment surface is formed by the surface 222b of the outer peripheral portion 222 of the first adhesive layer 22 on the side opposite to the label body and the surface 24b of the second adhesive layer 24 on the side opposite to the label body. Thus, the medical device RFID label 20 can be kept attached to the blood collection tube 1, which is an adherend, for a long time, and can be made difficult to peel from the blood collection tube 1.

In the medical device RFID label 20, the IC chip 232 and the antenna 233 can be provided on the second surface 231b of the base film 231, and the second adhesive layer 24 can be provided on the second surface 231b of the base film 231 so as to cover the IC chip 232 and the antenna 233. Thus, in the medical device RFID label 20, the level difference between the IC chip 232 and the antenna 233 of the label body 21 can be cancelled out by the second adhesive layer 24 when the label body 21 is printed. In the medical device RFID label 20, the level difference between the center portion of the label body 21 (the region corresponding to the intermediate portion 221 of the first adhesive layer 22) and the peripheral portion thereof (the region corresponding to the outer peripheral portion 222 of the first adhesive layer 22) can be reduced, and the printing surface of the label body 21 can be smoothed, so that the printing performance on the label body 21 can be improved.

In the medical device RFID label 20, the release paper 25 is provided across the surface 222b of the outer peripheral portion 222 of the first adhesive layer 22 on the side opposite to the label body and the surface 24b of the second adhesive layer 24 on the side opposite to the label body, so that the bending rigidity of the release paper 25 can be made less than the bending rigidity of the label body 21. Thus, in the medical device RFID label 20, the printing surface of the label body 21 can be smoothed by cancelling out the level difference on the adhesive surface with the release paper 25 while the bending rigidity of the label body 21 is enhanced, so that the printing performance can be improved when the label body 21 is printed on.

In the medical device RFID label 20, thermal paper can be used for the label body 21. Thus, the medical device RFID label 20 can be properly printed while heating the label body 21.

In the medical device RFID label 20, at least the first surface 21a of the label body 21 can be subjected to an alcohol-resistant treatment. Thus, in the medical device RFID label 20, even if alcohol comes into contact with the printing surface of the label body 21, peeling of the print can be reduced.

In the medical device RFID label 20, the center portion of the label body 21 and the center portion of the base film 231 are arranged so as to overlap each other in a plan view, and the area of the first adhesive layer 22 in a plan view can be made 1.5 to 3 times the area of the second adhesive layer 24. Thus, the first adhesive layer 22 can be prevented from protruding from the outer periphery of the medical device RFID label 20 when the label body 21 is printed, and the adhesion to the blood collection tube 1 can be maintained more reliably. Therefore, in the medical device RFID label 20, it is possible to further prevent soiling of the printing apparatus or the label body 21 of the other medical device RFID label 20 when printing the label body 21, and the adhesion force with respect to the blood collection tube 1 can be maintained more reliably.

In the medical device RFID label 20, the second adhesive layer 24 can be provided so as to be smaller in area than the first adhesive layer 22 in a plan view of the medical device RFID label 20. Thus, the area of contact of the first adhesive layer 22 with the blood collection tube 1 can be reduced. Therefore, even if the first adhesive layer 22 is deformed by pressing the medical device RFID label 20 from the outside when characters, figures, or the like are printed on the surface of the label body 21 by a printing device, the first adhesive layer 22 can adhere to the blood collection tube 1 while minimizing the amount of protrusion of the first adhesive layer 22 to the outside of the outer periphery of the medical device RFID label 20. By reducing the amount that the first adhesive layer 22 protrudes from the outer periphery of the medical device RFID label 20, it is possible to prevent the adhesion of the first adhesive layer 22 protruding from the outer periphery of the medical device RFID label 20 to the printing device when the label body 21 is printed. Thus, the medical device RFID label 20 can be prevented from soiling the printing device and the label body 21 of other medical device RFID labels 20 when the label body 21 is printed, and can be attached to the blood collection tube 1 while maintaining the adhesive force.

Further, the viscosity (peeling force) of the medical device RFID label 20 with respect to the release paper 25 can be suitably reduced by reducing the area where the first adhesive layer 22 comes into contact with the blood collection tube 1, so that the label body 21 can be smoothly conveyed when the label body 21 is conveyed to the printing device at the time of printing. Therefore, the medical device RFID label 20 can be prevented from causing failures in cueing (paper feed) when the label body 21 is printed in the printing device, so that the label body 21 can be properly printed. Further, the medical device RFID label 20 can be printed on the label body 21 at a deeper printing depth, so that the alcohol resistance can be improved.

Further, in the medical device RFID label 20, by reducing the area where the first adhesive layer 22 comes into contact with the blood collection tube 1, even when the medical device RFID label 20 is pressed inside the printing device, deformation of the thickness of the medical device RFID label 20 due to deformation of the first adhesive layer 22 can be prevented. Therefore, the medical device RFID label 20 can be prevented from causing chipping in the printed portion of the label body 21 when the label body 21 is printed, so that the occurrence of chip marks can be prevented.

The medical device RFID label 20 can be provided with at least a part of the base film 231 buried in the first adhesive layer 22. Thus, the medical device RFID label 20 can easily reduce the difference in thickness between the portion where the RFID inlay 23 is arranged and other portions. Therefore, the medical device RFID label 20 can further enhance the adhesive force to the blood collection tube 1, can more reliably maintain the adhesive force, and can more reliably prevent the occurrence of chipping in the printed portion of the label body 21 when the label body 21 is printed.

In the medical device RFID label 20, the first adhesive layer 22 and the second adhesive layer 24 can contain an acrylic resin. As a result, the first adhesive layer 22 and the second adhesive layer 24 can enhance transparency, adhesive force, reliability, weather resistance, heat resistance, and reworkability. Therefore, the medical device RFID label 20 can further enhance the adhesive force to the blood collection tube 1 and can enhance durability, so that the state of being attached to the blood collection tube 1 can be stably maintained.

### Examples

Embodiments will be described more specifically with reference to examples and comparative examples below, but the embodiments are not limited by these examples and comparative examples.

### Manufacture of Medical Device RFID Labels

### Example 1

An RFID inlay provided with an IC chip and an antenna on a base film (PET) was prepared. An acrylic adhesive was applied to the upper surface of the base film of the prepared RFID inlay to form a first adhesive layer. Thereafter, an acrylic adhesive was applied to the surface of the side of the RFID inlay where the IC chip and the antenna are arranged so that the applied area was smaller than that of the first adhesive layer in a plan view to form a second adhesive layer. Then, thermal paper was attached as a label body to the upper surface of the first adhesive layer, and release paper was attached to the lower surfaces of the first and second adhesive layers. Thus, medical device RFID labels were prepared.

### Physical Properties of the Adhesive

As the physical properties of the acrylic adhesive used, the adhesive force, the ball tack, and the holding force were measured. The measured adhesive force of the acrylic adhesive was 23.0 N/25 mm after 20 minutes and 23.3 N/25 mm after 24 hours of application on polyethylene (PE), and 24.4 N/25 mm after 20 minutes and 24.3 N/25 mm after 24 hours of application on stainless steel (SUS). The measured ball tack of the acrylic adhesive was 10 N/cm². The measured holding force of the acrylic adhesive was 429 minutes. The difference between the adhesive force measured 20 minutes after application of the acrylic adhesive and the adhesive force measured 24 hours after application of the acrylic adhesive tended to be small. This can be said to indicate that the acrylic adhesive developed a high adhesive force immediately after application and became difficult to peel off from the blood collection tube.

### Comparative Example 1

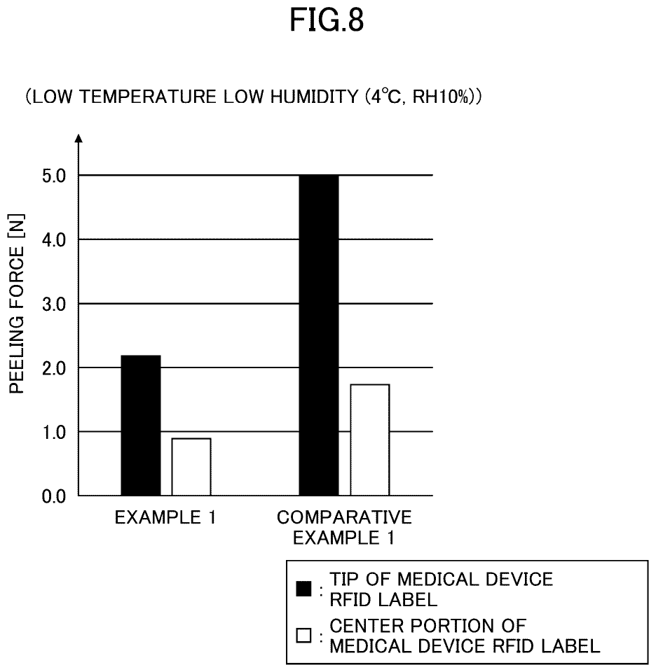

An RFID tag provided with an IC chip and an antenna was prepared on a base film (PET). A hot-melt adhesive was applied to the upper surface of the base film of the prepared RFID tag to form a hot-melt layer. Thereafter, an acrylic adhesive was applied to the surface of the side on which the IC chip and the antenna of the RFID tag were arranged so as to have an area approximately equal to that of the hot-melt layer in a plan view to form a second adhesive layer. Thereafter, thermal paper was attached to the upper surface of the hot-melt layer as a label body, and release paper was attached to the lower surfaces of the hot-melt layer and the second adhesive layer. Thus, medical device RFID labels as illustrated in FIG. 8 were prepared.

### Evaluation of Medical Device RFID Labels

### Overhang of First and Second Adhesive Layers

100 medical device RFID labels were manufactured, and each medical device RFID label was stored for 48 hours under a load of 20 kg applied from above the label in an environment of 40° C., and then the ends of the medical device RFID labels were observed to check the amount of overhang of the first and second adhesive layers. In Comparative Example 1, there were 5 medical device RFID labels that visually overhung by about 1 mm, but in Example 1, there were 0 medical device RFID labels that visually overhung by about 1 mm. Therefore, it can be said that the medical device RFID labels of Example 1 are less likely to soil the printer than the medical device RFID labels of Comparative Example 1.

### Peeling Force of Medical Device RFID Label

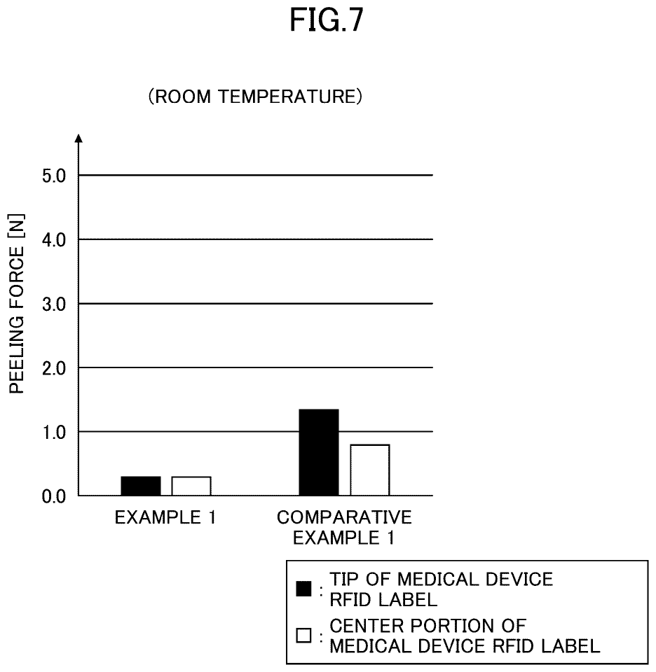

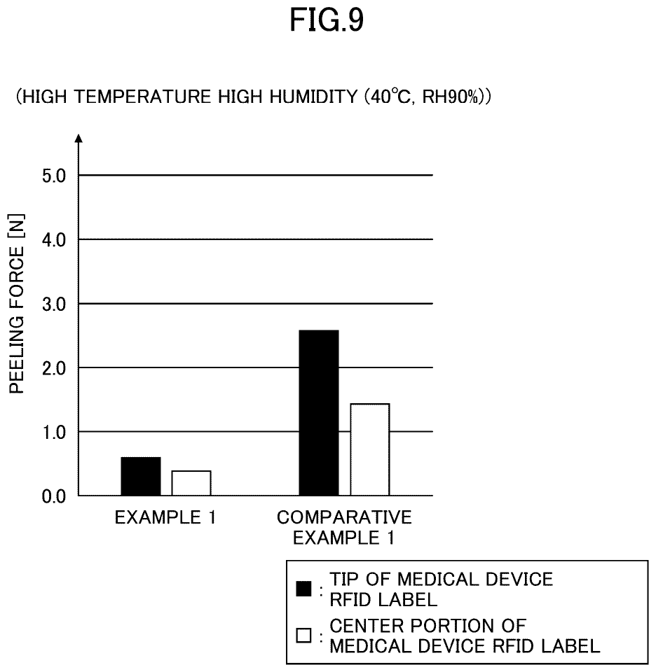

The manufactured medical device RFID label was fixed to a pedestal so that the release paper came into contact with the medical device RFID label, and the medical device RFID label was left for 4 hours. Then, the peeling force between the tip of the medical device RFID label and the center portion of the medical device RFID label was measured when the release paper was peeled, along the advancing direction, from the edge (the tip of the medical device RFID label) located on the advancing direction side when printed by a printing apparatus. The peeling force of the medical device RFID label was measured when the medical device RFID label was placed in an environment of room temperature (23° C.±2° C.), in an environment of low temperature and low humidity (4° C., RH 10%), and in an environment of high temperature and high humidity (40° C., RH 90%). Measurement results of measuring the peeling force of the medical device RFID label under various environments are illustrated in FIGS. 7 to 9. As illustrated in FIGS. 7 to 9, it was confirmed that the medical device RFID label of Example 1 had more stable peeling force than the medical device RFID label of Comparative Example 1 under each of the environments described above.

### Peeling from Blood Collection Tube

The manufactured medical device RFID label was left attached to a film cap tube under each of the environments 1 to 5 described below, and the peeling of the medical device RFID label from the blood collection tube was visually confirmed. As a result, peeling and lifting up were not confirmed in the medical device RFID label of Example 1 compared with the medical device RFID label of Comparative Example 1 under each of the environments described above.

### Environment

Environment 1: room temperature, in air, 48 hours
Environment 2: 37° C., in air, 48 hours
Environment 3: 4° C., in air, 48 hours
Environment 4: 4° C., in water, 24 hours→room temperature, 24 hours
Environment 5: 37° C., in water, 24 hours

### Evaluation by Printer

1300 sheets of manufactured medical device RFID labels were printed on thermal paper by using a commercially available printer serving as a printing device, and the peel angle, soiling on the printer, and chip marks on the thermal paper during printing were observed.

### (1) Peel Angle

As a result of visually measuring the peel angle, the peel angle of both the medical device RFID labels of Example 1 and the medical device RFID labels of Comparative Example 1 were almost the same, and no significant difference was observed.

### (2) Printer Soiling

As a result of visually observing the soiling on the printer, in the case where the medical device RFID labels of Example 1 were used, only a slight adhesion of glue was observed on the printer head, and no adhesion of soiling was observed on the printer pedestal. On the other hand, in the case where the medical device RFID labels of Comparative Example 1 were used, many adhesions of glue were observed on the printer head, and many adhesions of soiling were observed on the printer pedestal.

### (3) Chip Marks

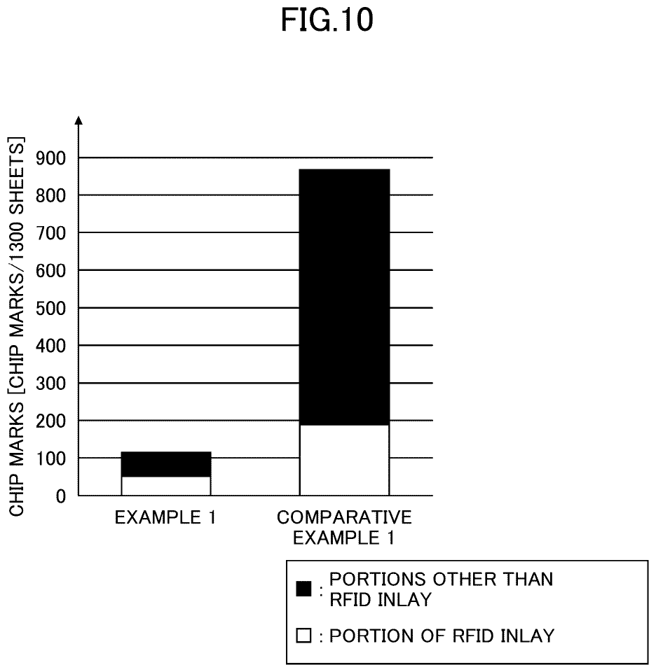

Chip marks were observed visually. The observation results of chip marks are illustrated in FIG. 10. As illustrated in FIG. 10, in the medical device RFID labels of Example 1, chip marks were barely confirmed, at about 120 chip marks/1300 sheets, but in the medical device RFID labels of Comparative Example 1, many chip marks were confirmed, at about 850 chip marks/1300 sheets. Therefore, it can be said that the medical device RFID label of Example 1 can greatly reduce chip marks compared to the medical device RFID label of Comparative Example 1.

### Alcohol Resistance

After the following pattern was printed on the label of the manufactured medical device RFID labels, an alcohol-impregnated nonwoven fabric was brought into contact with the label for 5 minutes in a printer print density setting ±0, and the nonwoven fabric was removed and the label was dried naturally. The medical device RFID labels of Example 1 were confirmed to have alcohol resistance as compared with the medical device RFID labels of Comparative Example 1. This is because the medical device RFID labels of Example 1 have a deeper printing depth when printed on thermal paper than the medical device RFID labels of Comparative Example 1.

Therefore, it can be said that the medical device RFID labels of Example 1 ameliorate the problem of peeling from the blood collection tube, make it difficult for the printer to get soiled when printing on thermal paper, make it easy for cueing by the printer, have excellent alcohol resistance, and reduce chip marks when printing on thermal paper.

Although the embodiments have been described above, the above embodiments are presented as examples, and the present invention is not limited by the above embodiments. The above embodiments can be embodied in various other forms, and various combinations, omissions, substitutions, changes, etc., can be made without departing from the gist of the present invention. These embodiments and variations thereof are included in the scope and gist of the present invention, and are included in the scope equivalent to the present invention described in the claims.

[1] An RFID label for a medical device to be attached to the medical device, the RFID label including:
a label body having a first surface on which printing is possible and a second surface on an opposite side of the first surface;
a first adhesive layer provided on the second surface of the label body;
an RFID inlay including
   a base film having a first surface attached to the second surface of the label body through the first adhesive layer and a second surface on an opposite side of the first surface, and having an area smaller than that of the label body,
   an antenna, and
   an IC chip; and
a second adhesive layer provided on the second surface of the base film, wherein
the first adhesive layer has an intermediate portion arranged between the label body and the base film, and an outer peripheral portion surrounding an outer periphery of the base film, and
a label attachment surface is formed by a surface of the outer peripheral portion of the first adhesive layer on an opposite side of the label body and a surface of the second adhesive layer on the opposite side of the label body.
   [2] The RFID label for the medical device according to [1], wherein
the antenna and the IC chip are provided on the second surface of the base film, and
the second adhesive layer is provided on the second surface of the base film and covers the IC chip and the antenna.
   [3] The RFID label for the medical device according to [1] or [2], further including: release paper provided across the surface of the outer peripheral portion of the first adhesive layer on the opposite side of the label body and the surface of the second adhesive layer on the opposite side of the label body, wherein the release paper has a bending rigidity lower than that of the label body.
   [4] The RFID label for the medical device according to any one of [1] to [3], wherein the label body is thermal paper.
   [5] The RFID label for the medical device according to any one of [1] to [4], wherein at least the first surface of the label body is subjected to an alcohol-resistant treatment.
   [6] The RFID label for the medical device according to any one of [1] to [5], wherein a center portion of the label body and a center portion of the base film are arranged so as to overlap each other in a plan view, and an area of the first adhesive layer in a plan view is 1.5 to 3 times an area of the second adhesive layer.

The present international application is based upon and claims priority to Japanese patent: application no. 2022-83421 filed with the Japan Patent Office on May 20, 2022, the entire contents of. which are incorporated herein by reference.

### REFERENCE SIGNS LIST

1 blood collection tube
20 medical device RFID label
21 label body
22 first adhesive layer
23 RFID inlay
232 IC chip
233 antenna
234 opening
24 second adhesive layer
25 release paper

1. An RFID label for a medical device to be attached to the medical device, the RFID label comprising:
a label body having a first surface on which printing is possible and a second surface on an opposite side of the first surface;
a first adhesive layer provided on the second surface of the label body;
an RFID inlay including
a base film having a first surface attached to the second surface of the label body through the first adhesive layer and a second surface on an opposite side of the first surface, and having an area smaller than that of the label body,
an antenna, and
an IC chip; and
a second adhesive layer provided on the second surface of the base film, wherein
the first adhesive layer has an intermediate portion arranged between the label body and the base film, and an outer peripheral portion surrounding an outer periphery of the base film, and
a label attachment surface is formed by a surface of the outer peripheral portion of the first adhesive layer on an opposite side of the label body and a surface of the second adhesive layer on the opposite side of the label body.

2. The RFID label for the medical device according to claim 1, wherein
the antenna and the IC chip are provided on the second surface of the base film, and
the second adhesive layer is provided on the second surface of the base film and covers the IC chip and the antenna.

3. The RFID label for the medical device according to claim 1, further comprising:
release paper provided across the surface of the outer peripheral portion of the first adhesive layer on the opposite side of the label body and the surface of the second adhesive layer on the opposite side of the label body, wherein
the release paper has a bending rigidity lower than that of the label body.

4. The RFID label for the medical device according to claim 1, wherein
the label body is thermal paper.

5. The RFID label for the medical device according to claim 1, wherein
at least the first surface of the label body is subjected to an alcohol-resistant treatment.

6. The RFID label for the medical device according to claim 1, wherein
a center portion of the label body and a center portion of the base film are arranged so as to overlap each other in a plan view, and
an area of the first adhesive layer in a plan view is 1.5 to 3 times an area of the second adhesive layer.
